(19) United States
(12) Patent Application Publication
(10) Pub. No.: US 2025/0075114 A1
(43) Pub. Date: Mar. 6, 2025

(54) PHASE-CHANGE HEAT STORAGE MICROCAPSULE MATERIAL SUITABLE FOR COOLING DRILLING FLUID AND PREPARATION METHOD THEREFOR

(71) Applicant: Southwest Petroleum University, Chengdu (CN)

(72) Inventors: Junlin SU, Chengdu (CN); Yi TAN, Chengdu (CN); Xinran DONG, Chengdu (CN); Ming DUAN, Chengdu (CN); Tao HE, Chengdu (CN); Huaizhi TAO, Chengdu (CN); Yufeng LUO, Chengdu (CN); Zhengguo ZHAO, Chengdu (CN)

(73) Assignee: Southwest Petroleum University, Chengdu (CN)

(21) Appl. No.: 18/555,443

(22) PCT Filed: Jun. 27, 2023
(86) PCT No.: PCT/CN2023/102690

§ 371 Date: Oct. 13, 2023

(30) Foreign Application Priority Data
Apr. 3, 2023 (CN) 202310345293.6

(51) Int. Cl. C09K 5/06; C09K 8/92

(52) U.S. Cl. CPC C09K 5/066; C09K 8/92

(57) ABSTRACT

The present disclosure belongs to the field of drilling fluid additives, and particularly relates to a phase-change heat storage microcapsule material suitable for cooling a drilling fluid and a preparation method therefor. The phase-change heat storage microcapsule material of the present disclosure consists of a high molecular wall material wrapped outside, a phase-change heat storage material as a core material and nano-graphite doped therein, and the microcapsules have an overall size within the range from 20 μm to 80 μm.

### CROSS REFERENCE TO RELATED APPLICATIONS

This application claims the benefit of Chinese patent application No. 202310345293. 6, filed on Apr. 3, 2023, the contents of which is specifically and entirely incorporated herein by reference.

### FIELD

The present disclosure relates to the field of drilling fluids in oil fields, in particular to a phase-change heat storage microcapsule material suitable for cooling a drilling fluid and a preparation method therefor. The technology uses the heat storage properties of a phase-change material for cooling drilling fluids in a high-temperature environment, which stabilizes the properties of the drilling fluids, so that the drilling fluids can work at a high temperature, belonging to the field of oil drilling materials.

### BACKGROUND

Existing oil exploration in china is facing a situation of being “low, deep, hidden, and difficult”. “Low” means that a target layer is mostly a low-porosity and low-permeability reservoir, “deep” means that the buried depth of oil and gas in the target layer is very large, “hidden” means that oil and gas reservoirs are hidden and difficult to explore, and “difficult” means that the exploration difficulty is in the increasingly difficult form. Field practice shows that in deep oil and gas drilling and development, drilling faces an increasing number of high temperature and ultra-high temperature problems, in the high-temperature environment where the bottom hole temperature is 180-260° C., it is difficult for each component of a drilling fluid to resist the high temperature to perform normal drilling operations, which will seriously affect the performance of the drilling fluid, and dispersion, degradation and the like occur to the components of the drilling fluid, resulting in a drastic change in rheological and fluid loss performance, making it difficult to perform the drilling operations. Not only that, instruments and equipment such as drilling tools, measurement while drilling and logging will also be subjected to inestimable serious influence in the face of the high temperature and ultra-high temperature environment, which greatly shortens their service life while also increasing drilling costs. In addition, with the development of geothermal resources and the successive implementation of deep scientific drilling engineering in china, there are more and more high temperature formations to be drilled, and the bottom hole temperature of dry hot rock high temperature wells is 200° C. or more, even more than 300° C. Therefore, the extremely harsh high-temperature and high-pressure environment such as deep oil and gas, dry hot rock, etc. poses severe challenge to the drilling fluid technology and downhole instruments and equipment, limiting the efficient drilling and development of deep oil and gas and geothermal clean resources.

To solve the high temperature and ultra-high temperature problems encountered by drilling fluids in the development of deep well resources, various studies have been carried out on the cooling of drilling fluids at home and abroad, but the current cooling method is mostly a ground cooling method, which only indirectly reduces the circulating temperature of the drilling fluids in wellbores by reducing the temperature at the inlet of drilling fluids, the equipment investment is large, the efficiency is not high, and it is difficult to meet the cooling requirements for high-temperature drilling in deep wells.

A phase-change material is a latent heat storage material, and has the advantages of large heat storage per unit volume, approximately isothermal heat storage and heat release process, stable chemical properties, and the like. The change in temperature and energy of the phase-change material when the phase change occurs is in the relationship: in a solid stage or in a stage of being completely changed to liquid of the phase-change material, the energy storage or release is achieved by the increase or decrease in temperature, which is a sensible heat energy storage stage; and during the phase change, the temperature is kept constant, and the energy storage or release is achieved through the phase change, which is a latent heat energy storage stage. Currently, phase-change materials are less studied and used in drilling fluids, with extremely high research values and prospects.

Microencapsulating the phase-change material can effectively prevent leakage of the internal phase-change material, and the phase-change material in micro-nano size distribution can pass through a drilling fluid shaker, making it possible to use the phase-change material with drilling fluid circulating, after one cycle, the phase-change material can be separated out from the drilling fluid with a special method, and then is added to the drilling fluid for a next cooling cycle after cooling recovery. Therefore, for the problem of drilling fluid cooling in high-temperature formation drilling, better and efficient application of the phase-change material to the problem of drilling fluid cooling is a frontier problem to be urgently solved.

### SUMMARY

For the shortcomings in the prior art, in particular the cooling requirements of a drilling fluid for drilling a deep well high-temperature formation, the present disclosure is invented, the present disclosure provides a phase-change heat storage microcapsule material suitable for cooling a drilling fluid and a preparation method therefor by utilizing the characteristics of large latent heat of phase change and constant temperature in the endothermic process of a phase change material, and the phase-change heat storage microcapsule material can play a role when the drilling fluid for drilling the high-temperature formation is heated to a certain temperature, and endothermic cooling is performed on the drilling fluid to achieve the effect of stabilizing the performance of the drilling fluid, ensuring the normal progress of drilling. The method is distinguished from the ground cooling method, and is carried out while drilling, and the phase-change heat storage microcapsule material is a drilling fluid additive that does not affect the performance of the drilling fluid while providing a drilling fluid cooling effect.

The technical solutions of the present disclosure are as follows:
in one aspect, the present disclosure provides a phase-change heat storage microcapsule material suitable for cooling a drilling fluid including a phase-change core material and a high molecular wall material coating the outer surface of the phase-change core material, wherein the high molecular wall material is an organic high molecular material modified by doping with nano-graphite, and the phase-change core material is erythritol.

According to the present disclosure, the organic high molecular material is polyethersulfone.

In another aspect, the present disclosure provides a method for preparing a phase-change heat storage microcapsule material suitable for cooling a drilling fluid comprising:
(1) dissolving 5-30% by mass of a high molecular wall material in an organic solvent to serve as an oil phase; and dissolving 5-40% by mass of a phase-change core material in deionized water to serve as an internal water phase:
(2) mixing the internal water phase with the oil phase, adding 0.5-2.5% by mass of a nano-inorganic material relative to the phase-change core material, then adding 1-3% by mass of an emulsifier relative to the oil phase, performing emulsification under high-speed stirring at 800 r/min-3000 r/min and performing ultrasonic dispersion to obtain a W/O emulsion:
(3) adding 1-2% by mass of polyvinylpyrrolidone and 1-3% by mass of a protective agent in deionized water, and performing uniform stirring to serve as an external water phase: maintaining the external water phase under stirring at a rotational speed of 800 r/min-3000 r/min, adding dropwise the W/O emulsion prepared in the step (2) into the external water phase to obtain a W/O/W multiphase emulsion, after completion of the dropwise addition, heating to 55-60° C., and stirring at a uniform speed for 4-6 h until the organic solvent is completely evaporated; and
(4) drying the W/O/W multiphase solution finally obtained in the step (3) at 65-75° C. for 6-36 h to obtain the phase-change heat storage microcapsule material suitable for cooling a drilling fluid.

In the method for preparing the phase-change heat storage microcapsule material suitable for cooling a drilling fluid according to the present disclosure, in the step (1), the high molecular wall material is polyethersulfone, the organic solvent is a mixed solution of chloroform and acetone in a ratio of 1:1.5, and the phase-change core material is erythritol.

In the method for preparing the phase-change heat storage microcapsule material suitable for cooling a drilling fluid according to the present disclosure, in the step (2), the internal water phase and the oil phase are used in a mass ratio of 1:(2-8), the nano-inorganic material is nano-graphite, the emulsifier is sodium dodecyl sulfate, the high-speed stirring is performed for 30-60 min, and the ultrasonic dispersion is performed for 15-30 min.

In the method for preparing the phase-change heat storage microcapsule material suitable for cooling a drilling fluid according to the present disclosure, in the step (3), the protective agent is a mixed solution of Span-60 and Tween-60, and a mixing ratio of Span-60 to Tween-60 is 1:1; and the external water phase and the oil phase are used in a mass ratio of 1:(2-8).

In the method for preparing the phase-change heat storage microcapsule material suitable for cooling a drilling fluid according to the present disclosure, the phase-change core material has a melting point within the range from 100° C. to 135° C. and latent heat of phase change within the range from 170 J/g to 290 J/g; and preferably, the phase-change core material has a melting point within the range from 106° C. to 134.3° C. and latent heat of phase change within the range from 229.1 J/g to 286.3 J/g.

According to the present disclosure, the nano-inorganic material has a particle size distribution within the range from 0.01 μm to 1 μm.

In the method for preparing the phase-change heat storage microcapsule material suitable for cooling a drilling fluid according to the present disclosure, the prepared microcapsule material has a particle size within the range from 20 μm to 80 μm; and preferably, the prepared microcapsule material has a particle size within the range from 20.6 μm to 79.2 μm, and a D₉₀ within the range from 59.3 μm to 77.0 μm.

The present disclosure has the following beneficial effects:
the phase-change heat storage microcapsule material suitable for cooling a drilling fluid according to the present disclosure uses a W/O/W double emulsion solvent evaporation method, by taking the phase-change heat storage properties of the phase-change material as a basis, when endothermic phase change occurs, the internal phase-change material erythritol enters a temperature platform stage that remains unchanged, by taking the high molecular material polyethersulfone as a coating shell of the phase-change material, leakage of the internal phase-change material is prevented, and meanwhile, polyethersulfone has excellent thermal stability, corrosion resistance and mechanical strength, it is ensured that the phase-change core material performs its normal function, and the doped nano-graphite can improve the disadvantage of poor thermal conductivity of the high molecular wall material, increase the heat transfer speed of the phase-change core material, raise the overall latent heat of phase change of the phase-change heat storage microcapsules and raise the encapsulation rate, but also increase the overall size of the microcapsules to some extent.

According to the phase-change heat storage microcapsule material suitable for cooling a drilling fluid of the present disclosure, when the external ambient temperature reaches within a small range temperature near its phase-change temperature point, an endothermic phase-change or exothermic phase-change behavior is generated, and the temperature is kept unchanged, through higher latent heat of phase change, the purpose of changing the external temperature is achieved, thereby acting as a cooling effect on the drilling fluid, maintaining the normal use of the drilling fluid under a high-temperature environment.

The phase-change heat storage microcapsule material suitable for cooling a drilling fluid according to the present disclosure can pass through a drilling fluid shaker, so that the material can be used with drilling fluid circulating, and can be reused, thus achieving the purpose of reducing drilling costs compared with the ground cooling method.

The phase-change heat storage microcapsule material suitable for cooling a drilling fluid of the present disclosure belongs to microsphere particles of a core-shell structure, is simple in preparation process and is easy for industrial production, and at the same time, has little influence on the fluidity of the drilling fluid, and is convenient for addition and construction.

### BRIEF DESCRIPTION OF THE DRAWINGS

In order to more clearly illustrate the embodiments of the present disclosure or the technical solution in the prior art, the drawings required to be used in the description of the embodiments or the prior art are simply introduced, obviously, the drawings in the following description are only some embodiments recorded in the present disclosure, and for those of ordinary skill in the art, other drawings can be obtained according to these drawings without inventive steps.

FIG. 1 is a table of test results for experimental schemes in Test example 1.

FIG. 2 is a schematic diagram showing the effect of the amount of nano-graphite added on the latent heat of phase change of a phase-change heat storage microcapsule material suitable for cooling a drilling fluid in Test example 1.

FIG. 3 is a table of test results for experimental schemes in Test example 2.

FIG. 4 is a schematic diagram comparing the temperature change curves of an experimental scheme b in Test example 2 and an experimental scheme #2.

FIG. 5 is a table of test results for experimental schemes in Test example 3.

FIG. 6 is a schematic diagram showing the effect of the amount of a phase-change heat storage microcapsule material suitable for cooling a drilling fluid added on the cooling effect of a drilling fluid in Test example 3.

### DETAILED DESCRIPTION

The endpoints and any values of the ranges pointed out herein are not limited to the precise range or value, and these ranges or values should be understood as including values close to these ranges or values. For numerical ranges, the endpoint values of each range, the endpoint values of each range and individual point values, and individual point values may be combined with each other to obtain one new numerical range, and these numerical ranges should be considered to be specifically disclosed herein.

As previously described, the first aspect of the present disclosure provides a phase-change heat storage microcapsule material suitable for cooling a drilling fluid including a phase-change core material and a high molecular wall material coating the outer surface of the phase-change core material, wherein the high molecular wall material is an organic high molecular material polyethersulfone modified by doping with nano-graphite, and the phase-change core material is erythritol.

The percentages described in the examples and test examples are mass fractions.

### Example 1

This example is used to illustratively describe a phase-change heat storage microcapsule material suitable for cooling a drilling fluid and a preparation method therefor according to the present disclosure.

The specific implementation steps are as follows:
(1) 25 g of polyethersulfone is dissolved in 200 mL of an organic solvent to serve as an oil phase; and 15 g of erythritol is dissolved in 50 mL of deionized water to serve as an internal water phase:
(2) the internal water phase and the oil phase are mixed in a ratio of 1:4, 0.075 g of nano-graphite is added, then 3 g of sodium dodecyl sulfate is added, and the mixture is emulsified under high-speed stirring at 1000 r/min and ultrasonically dispersed to obtain a W/O emulsion:
(3) 12 g of polyvinylpyrrolidone and 8 g of a protective agent are added in 800 mL of deionized water to be stirred uniformly to serve as an external water phase: the external water phase is maintained under stirring at a rotational speed of 1200 r/min, the W/O emulsion prepared in the step (2) is added dropwise into the external water phase to obtain a W/O/W multiphase emulsion, and after completion of the dropwise addition, heating is performed to 60° C., and stirring is performed at a uniform speed for 5 h until the organic solvent is completely evaporated; and
(4) the solution finally obtained in the step (3) is dried at 70° C. for 12 h to obtain a phase-change heat storage microcapsule material suitable for cooling a drilling fluid.

Wherein the organic solvent is chloroform and acetone which are mixed in a ratio of 1:1.5, and the protective agent is Span-60 and Tween-60 which are mixed in 1:1; this experimental scheme is named as an experimental scheme a (0.075 g of nano-graphite is added), by changing the amount of nano-graphite added in the step (2) to 0.15 g. 0.225 g, 0.3 g, and 0.375 g, respectively, an experimental scheme b, an experimental scheme c, an experimental scheme d, and an experimental scheme e can be obtained respectively, in addition, an experimental scheme without adding nano-graphite in the step (2) is named as an experimental scheme #1, and a drilling fluid without adding the phase-change heat storage microcapsule material suitable for cooling a drilling fluid of the present disclosure is named as an experimental scheme #2.

A phase-change heat storage microcapsule material suitable for cooling a drilling fluid can be prepared by the above steps.

### Example 2

This example is used to illustratively describe a water-based drilling fluid base slurry using the phase-change heat storage microcapsule material suitable for cooling a drilling fluid prepared in Example 1 of the present disclosure and a preparation method therefor.

The specific implementation steps are as follows:
(1) 25 g of polyethersulfone is dissolved in 200 mL of an organic solvent to serve as an oil phase; and 15 g of erythritol is dissolved in 50 mL of deionized water to serve as an internal water phase:
(2) the internal water phase and the oil phase are mixed in a ratio of 1:4, 0.15 g of nano-graphite is added, then 3 g of sodium dodecyl sulfate is added, and the mixture is emulsified under high-speed stirring at 1000 r/min and ultrasonically dispersed to obtain a W/O emulsion:
(3) 12 g of polyvinylpyrrolidone and 8 g of a protective agent are added in 800 mL of deionized water to be stirred uniformly to serve as an external water phase: the external water phase is maintained under stirring at a rotational speed of 1200 r/min, the W/O emulsion prepared in the step (2) is added dropwise into the external water phase to obtain a W/O/W multiphase emulsion, and after completion of the dropwise addition, heating is performed to 60° C., and stirring is performed at a uniform speed for 5 h until the organic solvent is completely evaporated:
(4) the solution finally obtained in the step (3) is dried at 70° C. for 12 h to obtain a phase-change heat storage microcapsule material suitable for cooling a drilling fluid; and
(5) a water-based drilling fluid base slurry containing 6% of sodium bentonite is prepared, after curing for 24 h, 3% of a sulfonated fluid loss agent, and 2% of a high temperature resistant lubricant are added, uniform stirring is performed at a high speed, then 2% of a phase-change heat storage microcapsule material suitable for cooling a drilling fluid is added into the prepared drilling fluid, and stirring is performed at a high speed for 30 min to ensure the phase-change heat storage microcapsule material is well dispersed in the drilling fluid, which is named as an experimental scheme a;
wherein the organic solvent is chloroform and acetone which are mixed in a ratio of 1:1.5, and the protective agent is Span-60 and Tween-60 which are mixed in 1:1; and the amount of the phase-change heat storage microcapsule material suitable for cooling a drilling fluid added in the step (5) is adjusted to 5%, 8%, 10%, and 15%, respectively, which are named as an experimental scheme b, an experimental scheme c, an experimental scheme d, and an experimental scheme e, respectively.

In Example 2, it should be noted that:
the experimental scheme a is a water-based drilling fluid base slurry containing 2% of the phase-change heat storage microcapsule material: the experimental scheme b is a water-based drilling fluid base slurry containing 5% of the phase-change heat storage microcapsule material: the experimental scheme c is a water-based drilling fluid base slurry containing 8% of the phase-change heat storage microcapsule material: the experimental scheme d is a water-based drilling fluid base slurry containing 10% of the phase-change heat storage microcapsule material: the experimental scheme e is a water-based drilling fluid base slurry containing 15% of the phase-change heat storage microcapsule material; wherein 0.15 g of nano-graphite is added in the phase-change heat storage microcapsule material, i.e., the phase-change heat storage microcapsule material prepared in the experimental scheme b in Example 1.

### Test Example 1

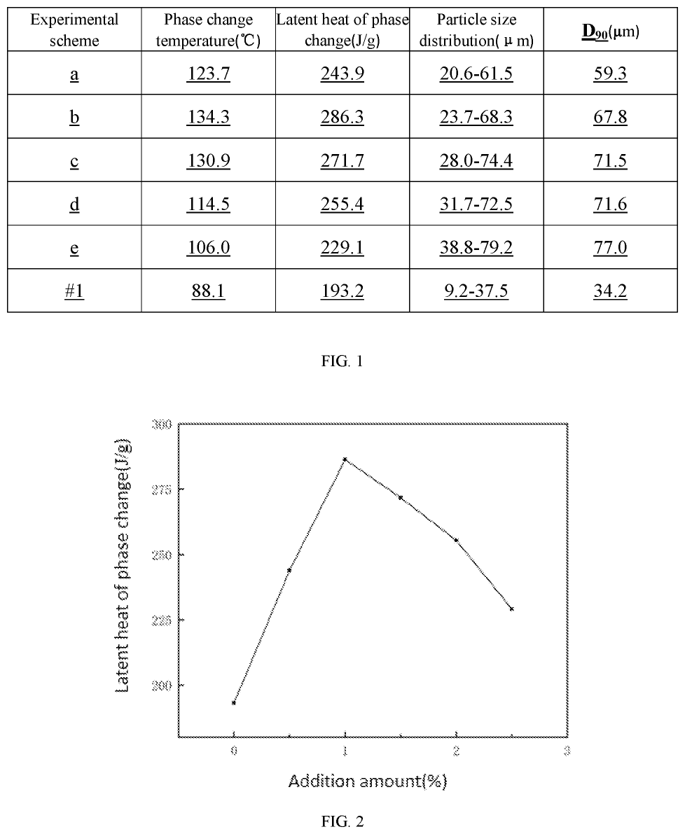

The phase change temperature and the latent heat of phase change of the phase-change heat storage microcapsule materials suitable for cooling a drilling fluid prepared in the experimental scheme a, the experimental scheme b, the experimental scheme c, the experimental scheme d, and the experimental scheme e in Example 1 are tested by a differential scanning calorimeter, and its particle size distribution is tested by a laser particle sizer, and the results are shown in FIG. 1, wherein the experimental scheme #1 in FIG. 1 is a phase-change heat storage microcapsule material suitable for cooling a drilling fluid without adding nano-graphite under the same steps.

As can be seen from the data of FIG. 1, the phase change temperature and the latent heat of phase change of the phase-change heat storage microcapsule material suitable for cooling a drilling fluid with the addition of nano-graphite according to the present disclosure can be increased to different degrees compared with those of a material without adding nano-graphite. This is because the incorporation of the highly thermally conductive material nano-graphite greatly improves the heat transfer limitation of the high molecular wall material of the microcapsules, so that the overall heat transfer efficiency of the microcapsules can be improved, and the surface of the high molecular wall material is smoother, increasing the spheroidization rate of the microcapsules, and in the experimental scheme b of Example 1, it can be seen that the phase change temperature is increased to 134.3° C., and the phase-change heat storage microcapsule material can be better applied to high-temperature formations as a drilling fluid cooling additive.

After doping with nano-graphite in the present disclosure, the latent heat of phase change is not less than 220 J/g, and a change curve of the latent heat of phase change corresponding to different amounts of nano-graphite added in the experimental schemes in Example 1 is shown in FIG. 2. From FIG. 2, it can be seen that when the amount of nano-graphite added is 1%, i.e., the experimental scheme b in Example 1, the latent heat of phase change is increased to 286.3 J/g, and the latent heat of phase change of the experimental schemes with the addition of nano-graphite (the experimental scheme a, the experimental scheme b, the experimental scheme c, the experimental scheme d, and the experimental scheme e) are all higher than that of the experimental scheme without addition of nano-graphite (the experimental scheme #1), this is due to the high heat transfer performance of the nano-graphite material, which greatly improves the heat transfer effect of the organic high molecular wall material on the phase-change core material, and increases the overall latent heat of phase change of the microcapsules.

### Test Example 2

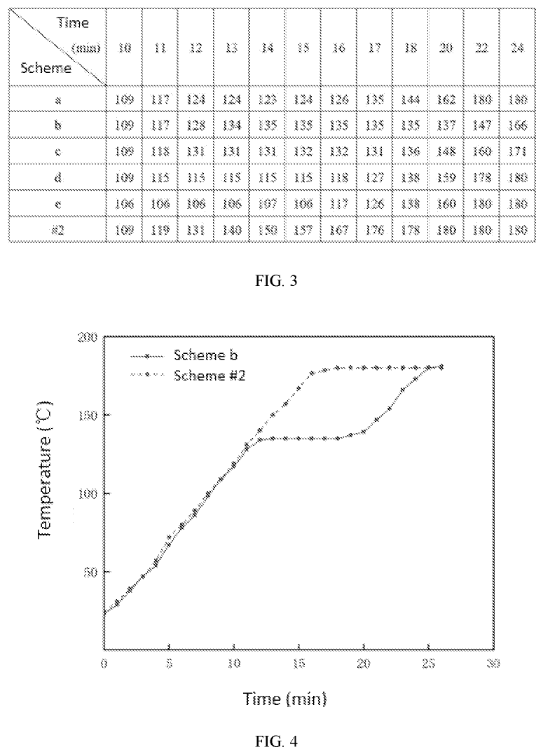

The drilling fluid circulation environment is simulated by a special instrument, 10% of the phase-change heat storage microcapsule materials suitable for cooling a drilling fluid in the experimental schemes a-e in Example 1 are respectively added to a drilling fluid containing 6% of sodium bentonite, 3% of a sulfonated fluid loss agent, and 2% of a high temperature resistant lubricant, the temperature is then increased to 180° C., and the drilling fluid is repeatedly circulated for 100 times or more. The change in drilling fluid temperature is recorded. The test results are shown in FIG. 3. The experimental scheme #2 in FIG. 3 is a drilling fluid without adding the phase-change heat storage microcapsule material suitable for cooling a drilling fluid of the present disclosure. The data in the table are in ° C.

As can be seen from FIG. 3, after the phase-change heat storage microcapsule material suitable for cooling a drilling fluid is added to the drilling fluid, the temperature of the drilling fluid can be effectively reduced, wherein the cooling effect in the experimental scheme b is the most obvious. FIG. 4 is a graph comparing the temperature rise curves of the experimental scheme b and the experimental scheme #2. It can be seen that after the experimental scheme b produces a platform stage at about 135° C., the continued increase of the temperature of the drilling fluid is effectively controlled.

In Test example 2, in FIG. 3, it should be noted that:
the experimental scheme a is a water-based drilling fluid base slurry containing 10% of the phase-change heat storage microcapsule material in the experimental scheme a prepared in Example 1;
the experimental scheme b is a water-based drilling fluid base slurry containing 10% of the phase-change heat storage microcapsule material in the experimental scheme b prepared in Example 1;
the experimental scheme c is a water-based drilling fluid base slurry containing 10% of the phase-change heat storage microcapsule material in the experimental scheme c prepared in Example 1;
the experimental scheme d is a water-based drilling fluid base slurry containing 10% of the phase-change heat storage microcapsule material in the experimental scheme d prepared in Example 1; and
the experimental scheme e is a water-based drilling fluid base slurry containing 10% of the phase-change heat storage microcapsule material in the experimental scheme e prepared in Example 1. In addition, in FIG. 4, the experimental scheme b is a water-based drilling fluid base slurry containing 10% of the phase-change heat storage microcapsule material in the experimental scheme b prepared in Example 1.

### Test Example 3

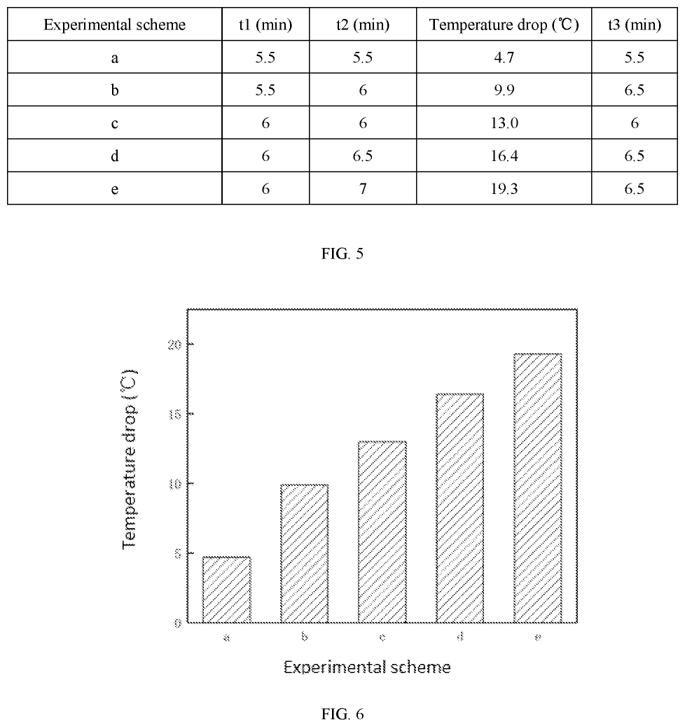

The drilling fluid circulation environment is simulated by a special instrument, and the water-based drilling fluid base slurries in the experimental schemes a-e in example 2 are respectively heated to 180° C., and the drilling fluid is repeatedly circulated for 100 times or more, and the change in drilling fluid temperature is recorded, and after heating to 180° C., the phase-change heat storage microcapsule material suitable for cooling a drilling fluid is separated out, and after the phase-change heat storage microcapsule material suitable for cooling a drilling fluid is cooled, it is added to a drilling fluid again. The test results are shown in FIG. 5, wherein t1 represents the time during which the drilling fluid is heated to the temperature of the platform stage, t2 is the time when the temperature is raised to 180° C. after the temperature of the platform stage, the temperature drop represents the temperature drop of the drilling fluid after the phase-change heat storage microcapsule material suitable for cooling a drilling fluid is added again after the separation, and t3 is the time required to raise the temperature to 180° C. again.

In FIG. 5, the addition amount of the phase-change heat storage microcapsule materials suitable for cooling a drilling fluid in the experimental schemes a-e of Example 2 is sequentially increased, and it can be seen that with the increase of the addition amount, the temperature of the platform stage remains slightly improved, and the time for the drilling fluid to be continued to be heated is delayed. FIG. 6 shows the temperature drop at different addition amounts. It can be seen that with the increase of the addition amount, the temperature drops more obviously after the phase-change heat storage microcapsule material suitable for cooling a drilling fluid is added to a drilling fluid again.

In Test example 3, in FIG. 5 and FIG. 6, it should be noted that:
the experimental scheme a is a water-based drilling fluid base slurry containing 2% of the phase-change heat storage microcapsule material: the experimental scheme b is a water-based drilling fluid base slurry containing 5% of the phase-change heat storage microcapsule material; the experimental scheme c is a water-based drilling fluid base slurry containing 8% of the phase-change heat storage microcapsule material: the experimental scheme d is a water-based drilling fluid base slurry containing 10% of the phase-change heat storage microcapsule material: the experimental scheme e is a water-based drilling fluid base slurry containing 15% of the phase-change heat storage microcapsule material; wherein 0.15 g of nano-graphite is added in the phase-change heat storage microcapsule material, i.e., the phase-change heat storage microcapsule material prepared in the experimental scheme b in Example 1.

The specific technical solutions described above are only used to illustrate the present disclosure, and are not used to limit the present disclosure. Although the present disclosure is described in detail with reference to the above specific technical solutions, within the scope of the technical idea of the present disclosure, many simple variations can be made to the technical solutions of the present disclosure, including the combinations of various technical features in any other suitable manner, and it should be understood that any modifications and equivalent replacements made based on the spirit and principle of the present disclosure should be regarded as the contents disclosed by the present disclosure, and are intended to be included within the protection scope of the present disclosure.

1. A method for preparing a phase-change heat storage microcapsule material suitable for cooling a drilling fluid comprising:
(1) dissolving 5-30% by mass of a high molecular wall material in an organic solvent to serve as an oil phase; and dissolving 5-40% by mass of a phase-change core material in deionized water to serve as an internal water phase;
(2) mixing the internal water phase with the oil phase, adding 0.5-2.5% by mass of a nano-inorganic material relative to the phase-change core material, then adding 1-3% by mass of an emulsifier relative to the oil phase, performing emulsification under high-speed stirring at 800 r/min-3000 r/min and performing ultrasonic dispersion to obtain a W/O emulsion;
(3) adding 1-2% by mass of polyvinylpyrrolidone and 1-3% by mass of a protective agent in deionized water, and performing uniform stirring to serve as an external water phase; maintaining the external water phase under stirring at a rotational speed of 800 r/min-3000 r/min, adding dropwise the W/O emulsion prepared in the step (2) into the external water phase to obtain a W/O/W multiphase emulsion, after completion of the dropwise addition, heating to 55-60° C., and stirring at a uniform speed for 4-6 h until the organic solvent is completely evaporated; and
(4) drying the W/O/W multiphase solution finally obtained in the step (3) at 65-75° C. for 6-36 h to obtain the phase-change heat storage microcapsule material suitable for cooling a drilling fluid.

2. The method of claim 1, wherein in the step (1), the high molecular wall material is polyethersulfone, the organic solvent is a mixed solution of chloroform and acetone in a ratio of 1:1.5, and the phase-change core material is erythritol.

3. The method of claim 1, wherein in the step (2), the internal water phase and the oil phase are used in a mass ratio of 1:(2-8), the nano-inorganic material is nano-graphite, the emulsifier is sodium dodecyl sulfate, the high-speed stirring is performed for 30-60 min, and the ultrasonic dispersion is performed for 15-30 min.

4. The method of claim 1, wherein in the step (3), the protective agent is a mixed solution of Span-60 and Tween-60, and a mixing ratio of Span-60 to Tween-60 is 1:1; and the external water phase and the oil phase are used in a mass ratio of 1:(2-8).

5. The method of claim 1, wherein the nano-inorganic material has a particle size distribution within the range from 0.01 μm to 1 μm.

6. A phase-change heat storage microcapsule material suitable for cooling a drilling fluid prepared by the method of claim 1.

7. The phase-change heat storage microcapsule material suitable for cooling a drilling fluid of claim 6, wherein the phase-change heat storage microcapsule material includes a phase-change core material and a high molecular wall material coating the outer surface of the phase-change core material, wherein the high molecular wall material is an organic high molecular material polyethersulfone modified by doping with nano-graphite, and the phase-change core material is erythritol.

8. The phase-change heat storage microcapsule material suitable for cooling a drilling fluid of claim 6, wherein the phase-change core material has a melting point within the range from 100° C. to 135° C., and latent heat of phase change within the range from 170 J/g to 290 J/g after microencapsulation.

9. The phase-change heat storage microcapsule material suitable for cooling a drilling fluid of claim 8, wherein the phase-change core material has a melting point within the range from 106° C. to 134.3° C., and latent heat of phase change within the range from 229.1 J/g to 286.3 J/g after microencapsulation.

10. The phase-change heat storage microcapsule material suitable for cooling a drilling fluid of claim 6, wherein the phase-change heat storage microcapsule material suitable for cooling a drilling fluid has a particle size within the range from 20 μm to 80 μm; and preferably, the phase-change heat storage microcapsule material suitable for cooling a drilling fluid has a particle size within the range from 20.6 μm to 79.2 μm, and a D₉₀ within the range from 59.3 μm to 77.0 μm.
